(19) United States
(12) Patent Application Publication
(10) Pub. No.: US 2026/0226630 A1
(43) Pub. Date: Aug. 6, 2026

(54) SYSTEMS AND METHODS FOR ELECTROCHEMICAL GENERATION OF ACID AND BASE

(71) Applicant: SHYP BV PBC, Baltimore, MD (US)

(72) Inventors: Daniel Vincent ESPOSITO, Mount Vernon, NY (US); Lauren GREENLEE, Wilmington, DE (US)

(21) Appl. No.: 19/148,948

(22) PCT Filed: Dec. 12, 2023
(86) PCT No.: PCT/US2023/083500

§ 371 Date: Jul. 17, 2025

Related U.S. Application Data
(60) Provisional application No. 63/439,677, filed on Jan. 18, 2023.

(51) Int. Cl. C25B 1/04; C25B 9/65; C25B 9/70; C25B 11/031; C25B 15/08

(52) U.S. Cl. CPC C25B 1/04; C25B 9/65; C25B 9/70; C25B 11/031; C25B 15/08

(57) ABSTRACT

An electrolytic device including a housing and at least one electrolytic cell disposed in the housing. The electrolytic cell includes a porous cathode, a porous anode, and a porous divider disposed between the porous cathode and the porous anode. The porous divider, the porous cathode and the porous anode form an integral structure that separates the at least one electrolytic cell into a first chamber and a second chamber with the porous cathode located in the first chamber and the porous anode located in the second chamber. Reactive gas generated at one of the porous cathode or porous anode passes through the integral structure to the other of the porous anode or porous cathode so that external separation and recycling of reactive gases is not required.

### FIELD OF THE INVENTION

The present invention generally relates to electrochemical devices, and in particular to electrochemical devices that use electrolytic reactions to form acid and base.

### BACKGROUND

Electrolysis is a very important industrial process used to produce a variety of vital chemical building blocks. Processes such as the chlor-alkali process, electro-synthesis of anthraquinone, and electro-fluoridation all play essential roles in the production of chemicals used in our everyday lives. Electrolysis can be an energy efficient process with a significantly lower carbon footprint compared to traditional thermal catalysis processes if the input electricity is derived from a renewable resource such as wind or solar. As of 2006, chemical production by electrochemical processes made up more than 6% of the total electrical generating capacity of the United States, with the most energy intensive process as being performed by the chlor-alkali industry. These processes are used to produce hydrogen gas, caustic soda (sodium hydroxide), and chlorine gas. For the chlor-alkali processes, and most electrolysis processes, the economics are dominated by the cost of electricity, which accounts for a significant fraction of the total manufacturing cost. However, the decreasing costs of electricity from renewable resources and the continued adoption of time-of-use pricing schemes are likely to change the economics of electrochemical processes, shifting importance towards decreasing the capital cost of the electrolyzer system itself.

The process chemistry of the chlor-alkali process is relatively simple but the operational and reactor design issues are vastly complex. The most energy efficient electrolyzer in the chlor-alkali industry is the membrane electrolyzer. The membrane electrolyzer functions by separating anolyte and catholyte streams by means of an ion selective membrane and that only allows cationic species (e.g., Na+, K+, H+) and small amounts of water to pass through it. Diaphragm electrolyzers and mercury electrolytic cells are also used to produce bases, although these technologies are being phased out in favor of membrane reactors. This is due to health and environmental concerns relating to the use of asbestos and mercury, respectively. Key challenges with membrane electrolyzers include the high cost of the ion-selective membranes and their susceptibility to fouling. Various approaches have been pursued in order to improve the yield, energy efficiency, economics, and environmental impacts of the membrane process.

Efforts have been made to address the problems with membrane electrolyzers by introducing so-called “membrane-free” electrolyzers. These electrolyzers operate without membranes due to the use of porous electrodes combined with flow-induced separation of products before they can cross over between anolyte and catholyte effluent streams. The simplicity of such designs allows them to be fabricated by low-cost manufacturing techniques (e.g., injection molding) and thereby offers great promise for decreasing the capital costs associated with electrolysis processes. Membrane-free electrolyzers are described in U.S. Pat. No. 10/844,494, U.S. Patent Application Publication No. 2022-0194823, U.S. Patent Application Publication No. 2021-0188711, PCT Application Publication No. WO2020/198350 and PCT Application Publication No. WO2022/104242, the contents of which are incorporated herein by reference in their entirety. A common feature of membrane-free electrolyzers to date is that they require complicated management of flowing multi-phase (i.e., gas and liquid) streams and in some cases external phase separator and recycle streams to recycle unused reactive gas (e.g., H₂) back to the anode.

### SUMMARY OF THE INVENTION

An object of the present invention is to provide a membrane-free electrolyzer that is suitable for a variety of electrochemical processes and which does not require external separation and recycling of reactive gases.

Another object of the present invention is to provide a membrane-free electrochemical device that generates alkaline (i.e., basic) and acidic effluent streams from brine (i.e., salt) solutions in a self-contained structure that does not require any external separation and recycling of reactive gases.

An electrolytic device according to an exemplary embodiment of the present invention comprises: a housing; and at least one electrolytic cell disposed in the housing and comprising: a porous cathode; a porous anode; a porous divider disposed between the porous cathode and the porous anode, with the porous divider, the porous cathode and the porous anode forming an integral structure that separates the at least one electrolytic cell into a first chamber and a second chamber with the porous cathode located in the first chamber and the porous anode located in the second chamber; at least one inlet for delivery of electrolyte to the porous cathode and the porous anode; a first outlet for delivery of alkaline effluent from the first chamber; and a second outlet for delivery of acidic effluent from the second chamber, wherein reactive gas generated at one of the porous cathode or porous anode passes through the integral structure to the other of the porous anode or porous cathode.

In an exemplary embodiment the at least one electrolytic cell comprises a plurality of electrolytic cells.

In an exemplary embodiment the porous divider comprises a first layer disposed between a second and third layer, wherein the first layer is denser than the second and third layers.

In an exemplary embodiment the porous divider comprises a first layer disposed between a second and third layer, wherein the first layer is less dense than the second and third layers.

In an exemplary embodiment the divider comprises at least one channel extending through the thickness of the divider.

In an exemplary embodiment the at least one inlet comprises two inlets with one inlet for delivery of electrolyte to the cathode and another inlet for delivery of electrolyte to the anode.

In an exemplary embodiment the plurality of electrolytic cells are arranged in a side-by-side, parallel plate configuration.

In an exemplary embodiment the cathode of each electrolytic cell directly faces the anode of an adjacent electrolytic cell.

In an exemplary embodiment the electrolytic device further comprises a common manifold for delivery of electrolyte to each of the at least one inlets of the plurality of electrolytic cells.

In an exemplary embodiment the electrolytic device further comprises a common manifold for collection of alkaline effluent from each of the first outlets of the plurality of electrolytic cells.

In an exemplary embodiment the electrolytic device further comprises a common manifold for collection of acidic effluent from each of the second outlets of the plurality of electrolytic cells.

In an exemplary embodiment the electrolytic device further comprises a common anode busbar electrically connected to each of the anodes of the plurality of electrolytic cells.

In an exemplary embodiment the electrolytic device further comprises a common cathode busbar electrically connected to each of the cathodes of the plurality of electrolytic cells.

In an exemplary embodiment the plurality of electrolytic cells are electrically connected in series so that the electrolytic device has only a single positive terminal at one end of the device and only a single negative terminal at an opposite end of the device.

In an exemplary embodiment each of the plurality of electrolytic cells are separate modular components that are attachable together to form the electrolytic device.

In an exemplary embodiment the plurality of electrolytic cells comprise a first level of electrolytic cells and at least one other level of electrolytic cells disposed over the first level.

In an exemplary embodiment alkaline effluent generated at the at least one other level of electrolytic cells is directed to the first level of electrolytic cells.

In an exemplary embodiment acidic effluent generated at the at least one other level of electrolytic cells is directed to the first level of electrolytic cells.

In an exemplary embodiment polarity of the cathode and anode is switched to dissolve impurity species from the electrolyte that deposit on the cathode and anode during operation.

In an exemplary embodiment the alkaline effluent is recirculated back to the porous cathode.

In an exemplary embodiment the acidic effluent is recirculated back to the porous anode.

In an exemplary embodiment the electrolyte is delivered in a pulsed sequence.

### BRIEF DESCRIPTION OF THE DRAWINGS

FIGS. 1A and 1B show two different electrochemical schemes for producing acid and base;

FIG. 2 illustrates a single cell electrolytic device according to an exemplary embodiment of the present invention;

FIG. 3A-3D illustrate different configurations of a divider-electrode assembly (DEA) according to an exemplary embodiment of the present invention;

FIGS. 4A and 4B are side views of showing different configurations of a DEA according to an exemplary embodiment of the present invention;

FIG. 5 illustrates a single cell electrolytic device according to another exemplary embodiment of the present invention;

FIG. 6 illustrates a multi-cell electrolytic device according to an exemplary embodiment of the present invention;

FIG. 7 illustrates a multi-cell electrolytic device according to another exemplary embodiment of the present invention;

FIG. 8 illustrates a multi-cell electrolytic device according to another exemplary embodiment of the present invention;

FIG. 9 illustrates a multi-cell electrolytic device according to another exemplary embodiment of the present invention;

FIG. 10 illustrates a single cell electrolytic device according to another exemplary embodiment of the present invention;

FIGS. 11A-11C illustrate an electrolytic device according to an exemplary embodiment of the present invention;

FIG. 12 illustrates a single cell electrolytic device according to an exemplary embodiment of the present invention;

FIG. 13A-13D illustrate end and middle components of a multi-cell electrolytic device according to an exemplary embodiment of the present invention;

FIGS. 14A-14C are photograph of a multi-cell electrolytic device according to an exemplary embodiment of the present invention; and FIGS. 15A and 15B are photographs of the multi-cell electrolytic device of FIGS. 14A-14C in a laboratory setting.

### DETAILED DESCRIPTION OF PREFERRED EMBODIMENTS

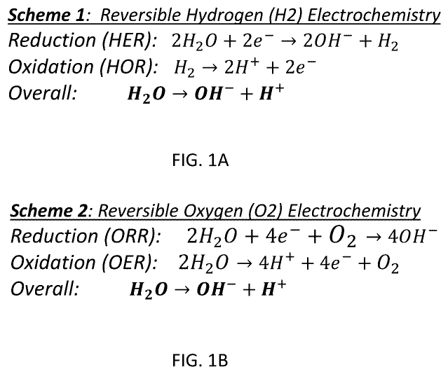

The following description relates to various exemplary embodiments of an electrolyzer used with H₂ electrochemistry. However, it should be appreciated that the inventive electrolyzer described herein may also be used with O₂ electrochemistry. More specifically, without being bound by theory, two different electrochemical schemes are envisioned to be of primary interest for producing acid and base. Scheme 1 is shown in FIG. 1A and Scheme 2 is shown in FIG. 1B. Scheme 1 is based on H₂ electrochemistry for which H₂ is oxidized at the anode through the hydrogen oxidation reaction (HOR) and H₂ is generated at the cathode through the hydrogen evolution reaction (HER). Scheme 2 is based on O₂ electrochemistry for which O₂ is generated at the anode through the oxygen evolution reaction (OER) and O₂ is consumed at the cathode through the oxygen reduction reaction (ORR). For both schemes, the overall reaction involves converting the inlet brine solution into one effluent that is more alkaline and another effluent that is more acidic than the inlet brine, without net generation or consumption of O₂ or H₂. Without being bound by theory, Scheme 1 is the most desirable for applications in seawater or brine since the HOR can be used to generate acid without competing with the chlorine evolution reaction (CER) due to its lower standard reduction potential. Scheme 1 can be implemented in the most energy efficient manner due to the relatively fast kinetics for the HER/HOR compared to OER/ORR. Although less energy efficient that Scheme 1, Scheme 2 may be more convenient to use for some non-chloride/bromide containing solutions since it completely avoids the need for H₂. This can allow the use of open device/stack structures and minimize safety risks compared to a H₂-based system.

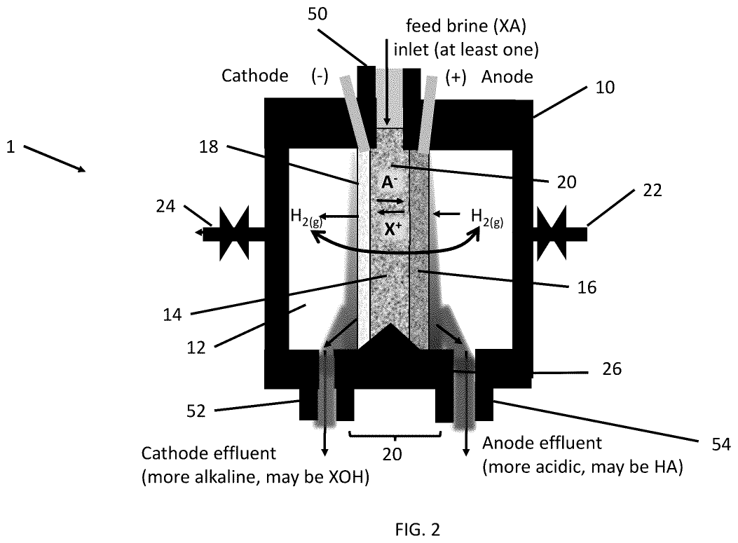

FIG. 2 shows a single cell electrolyzer, generally designated by reference number 1, according to an exemplary embodiment of the present invention. The electrolytic cell 1 includes a housing 10 with a hollow interior space 12 that is separated into two chambers by a porous divider 14. The divider 14 is interposed or sandwiched between a porous anode 16 (where the HOR occurs) and a porous cathode 18 (where HER occurs), so that the anode 16 is disposed in one chamber and the cathode 18 is disposed in the other chamber.

In exemplary embodiments, the divider 14 is made of materials that generally permit ion transport, but preferably do not facilitate selective ion transport (e.g., selective anion vs. cation transport) as in conventional ion exchange membranes. In general, the divider is preferably made of porous materials that are chemically and thermally stable for the target application, and which permit ion transport with relatively low ionic resistance. The materials also preferably have low electronic conductivity to avoid shorting between the two electrodes, with at least one layer of the divider 14 being not electrically conductive. Suitable materials for the divider 14 include but are not limited to the following: (i) carbon-based plastic/polymeric materials including but not limited nylon, Acrylonitrile butadiene styrene (ABS), polypropylene, polysulfones, polytetrafluoroethylene (PTFE); (ii) ceramic materials such as glass fibers or foams; (iii) non-polymeric carbon materials such as carbon paper, carbon cloth, or carbon foams, with or without surface functionalized to achieve desired chemical properties like hydrophilic character; and (iv) composite materials made of combinations of the above-mentioned materials.

The divider 14, anode 16 and cathode 18 may be combined together to form a divider-electrode assembly (DEA) 20. In exemplary embodiments, the DEA 20 is incorporated into the housing 10 in a way that facilitates (i) the delivery of an inlet liquid brine stream to at least one location near the top of the porous divider, (ii) collection and removal of an acidic liquid effluent stream from the anode side of the device, (iii) collection and removal of an alkaline liquid effluent stream from the cathode side of the device, (iv) delivery of H₂ to the device from an external H₂ source on an as-needed basis, and (v) free exchange of gaseous H₂ by free convection/diffusion between the gaseous chambers in contact with the cathode and anode. This last feature allows for H₂ generated at the cathode 18 to easily cross over to the anode 16 where it can be oxidized, obviating the need for collecting and recycling H₂ external to the device structure. In exemplary embodiments, feed brine may be delivered to the DEA 20 through at least one fluid inlet 50, and alkaline effluent and acidic effluent may be directed out of the cell 1 by respective fluid outlets 52, 54.

In exemplary embodiments, at least one port or valve is connected to the gaseous chambers adjacent to the anode and cathode to allow for the in-flow or out-flow of gases like H₂. For example, one inlet valve 22 might serve as a source of H₂ to be fed to the device from another H₂ source like a conventional water electrolyzer. Small rates of H₂ can be introduced to the device during operation to replace small amounts of dissolved H₂ that are lost through the liquid effluent streams. An outlet port or valve 24 might be connected to the internal gas chambers to allow for purging of the internal volume with either H₂ or a second internal gas, e.g., N₂, which may be used to eliminate O₂/air from the cell at start-up.

The enclosed cell design shown in FIG. 2 allows for operation at elevated pressure, which can be beneficial for increasing the mass transfer limiting current densities at the anode 16 for which H₂ is a reactant. In some exemplary embodiments, a wedge structure 26 is disposed at the bottom portion of the porous divider, helping to promote separation of the acidic brine draining from the porous anode 16 and the alkaline brine draining from the porous cathode 18.

During operation, a power supply (not shown) is used to apply a voltage across the two electrodes such that an acid-generating oxidation reaction (e.g., HOR) occurs at the porous anode 16 while a base-generating reduction reaction (e.g., HER) occurs at a porous cathode 18. Simultaneously, ionic current passes between the cathode 18 and anode 16 due to migration of cations (X+) and anions (A−) across the porous divider 14. Without being bound by theory, the concentrations of acid in the anode effluent stream and base in the cathode effluent stream are determined by (i) the average current density (reaction rate) at the electrodes, (ii) the volumetric flow rates of the brine solutions leaving the two effluent ports of the device, and (iii) the extent of recombination of H+ and OH− resulting from one or the other crossing over from the electrode they were generated at to the opposing effluent stream. It should be noted that the volumetric flow rate through the anode and cathode effluent streams need not be the same. In exemplary embodiments, the polarity of the electrodes may be occasionally switched during operation to reverse the pH in the anode and cathode layers to dissolve impurity species from the brine solution that deposit on the electrodes during operation. As discussed below, in exemplary embodiments, the concentration of acid and base may also be altered by fluidically connecting cells in series.

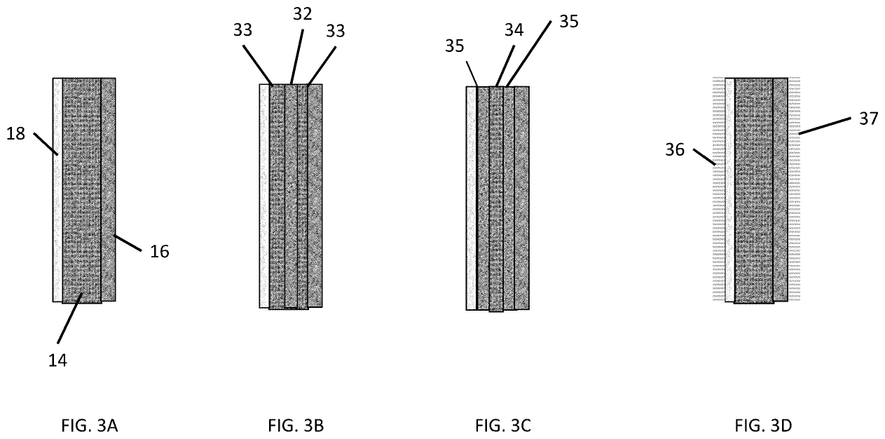

Referring now to FIGS. 3A-3D, the divider electrode assembly (DEA) 20 sub-section of the electrolyzer I can assume several different configurations. In one configuration (FIG. 3A), the porous divider is made of a single material with gradients of porosity so as to form a unitary structure. In other configurations (FIGS. 3B, 3C) the porous divider is made up of two or more different layers of the same or different materials having different compositions and/or structure. FIG. 3B shows an exemplary embodiment in which a dense porous layer 32 is sandwiched between two less dense porous layers 33 such that flow of the liquid electrolyte is favored in the downward direction through the less dense porous layers 33 compared to lateral (side-to-side) direction through the dense porous layer 32. This embodiment is most appropriate for use with a device body that allows the feed brine to be received from each side of the porous divider. FIG. 3C shows an exemplary embodiment in which a less dense porous layer 34 is sandwiched between two dense porous layers 35 such that flow of the liquid electrolyte is favored in the downward direction through the less dense porous layer 34, promoting uniform flow of the liquid brine electrolyte in the outward (side-to-side) direction through the denser porous layers 35. This embodiment is most appropriate for use with a device body that delivers feed brine through a single inlet stream that is received by the middle porous layer 34. As shown in FIG. 3D, for any of the divider-electrode assembly configurations, porous current collectors 36, 37 may be placed in physical contacts with the outer surfaces of the porous anodes and cathodes to facilitate transfer of electrical current between the electrodes and the external electrical connections of the device.

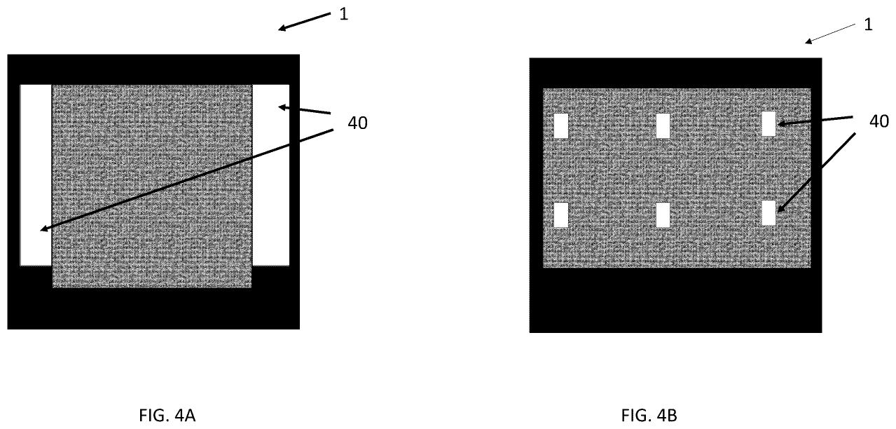

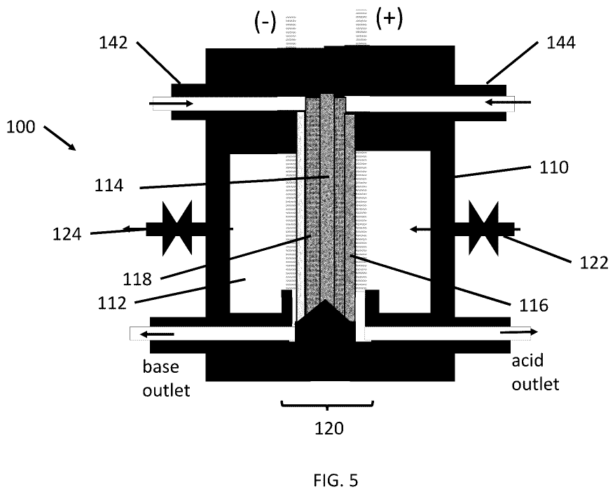

FIGS. 4A and 4B are side views of an electrolytic cell 1 showing different configurations of a DEA 30 according to exemplary embodiments of the present invention. The DEA 20 supported within the cell body contains openings or gas exchange channels that allow for free convection of gaseous species to transport between opposite sides of the DEA, as described above. FIG. 4A shows the gas exchange channels 40 extending across the front and back surfaces of the DEA 20, and FIG. 4B shows the gas exchange channels 40 extending through the interior of the DEA 20. It should be appreciated that the exact number and geometry of the gas exchange channels 40 is not limited to the descriptions provided herein so long as they allow for sufficient convective transport of H₂ from the cathode chamber to the anode chamber that matches the rate at which H₂ is consumed by the HOR.

For examples, the channels 40 may be holes, slits, etc. of varying shapes, sizes and patterns.

FIG. 5 shows an electrolytic cell, generally designated by reference number 100, according to another exemplary embodiment of the present invention. The electrolysis cell 100 is generally the same as the electrolysis cell 1 as described previously except for the modification of at least two fluidic inlet streams delivering feed brine to the DEA, as opposed to one inlet stream. The electrolysis cell 100 includes a housing 110 with a hollow interior space 112 that is separated into two chambers by a porous divider 114. The divider 114 is interposed or sandwiched between a porous anode 116 (where the HOR occurs) and a porous cathode 118 (where HER occurs), so that the anode 116 is disposed in one chamber and the cathode 118 is disposed in the other chamber. The divider 114, anode 116 and cathode 118 may be combined together to form a divider-electrode assembly (DEA) 120. The housing 110 is equipped with an inlet valve 122 and an outlet valve 124. A first fluidic feed channel 142 delivers feed brine to the cathode side of the DEA 120, and a second fluidic feed channel 144 delivers feed brine to the anode side of the DEA 120. The use of two separate feed channels allows for control of the relative flow rates down the anode and cathode side of the DEA 120.

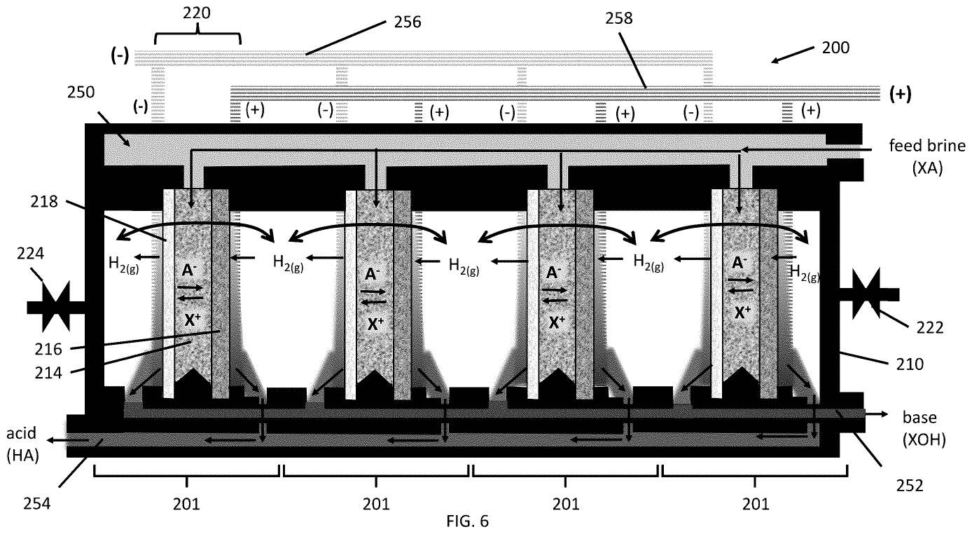

FIG. 6 shows a multi-cell acid-base electrolyzer or electrolyzer stack, generally designated by reference number 200, according to an exemplary embodiment of the present invention. In this embodiment, individual electrolysis cells 201 are combined to form a stack to increase the amount of acid and base produced. Each individual cell 201 may include the same components as the cells described previously, including a porous divider 214, a porous anode 216 and a porous cathode 218. Each group of divider 214, anode 216 and cathode 218 forms a separate divider-electrode assembly (DEA) 220. The cells 201 are contained in a common housing 210, which may include an inlet valve 222 and an outlet valve 224.

In embodiments, the cells 201 are placed in a side-by-side, parallel plate configuration, with anodes 216 and cathodes 218 of adjacent cells oriented to face each other and facilitate rapid transport of H₂ from each cathode 218 to each adjacent anode 216, decreasing the requirement for gas exchange channels to achieve the same purpose. In one embodiment, the feed brine enters a common feed channel or manifold 250 that simultaneously delivers brine to the multiple cells 201 placed in a side-by-side, parallel plate configuration. In some embodiments, the alkaline cathode effluent streams generated by each cell are combined into a single alkaline effluent stream, while the acidic anode effluent streams generated by each cell are combined into a single acidic effluent stream. In this regard, the single alkaline effluent stream may be directed into a common alkaline effluent channel or manifold 252 and the single acidic effluent stream may be directed into a common acidic effluent channel or manifold 254.

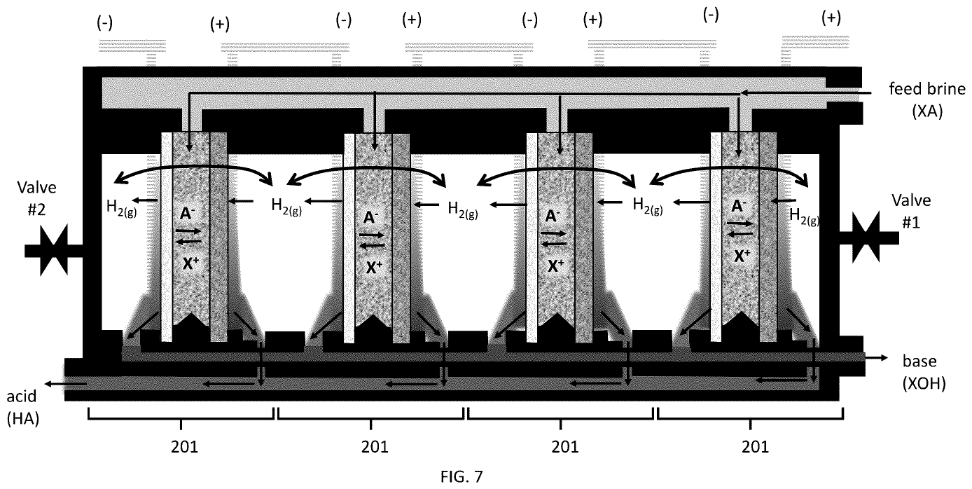

In exemplary embodiments, the electrical connections for the electrodes in the electrolyzer stack may be unipolar (i.e., cells connected in parallel), as shown in FIG. 6, where all of the cathodes 218 are connected to a common cathode busbar 256 and all of the anodes 216 are connected to a common anode busbar 258. Alternatively, as shown in FIG. 7, the cells 201 in the stack design may be electrically connected in a series through a so-called bipolar configuration whereby the current collectors of adjacent anodes 216 and cathodes 218 are connected to each other such that there is only a single positive terminal and a single negative terminal at each end of the stack.

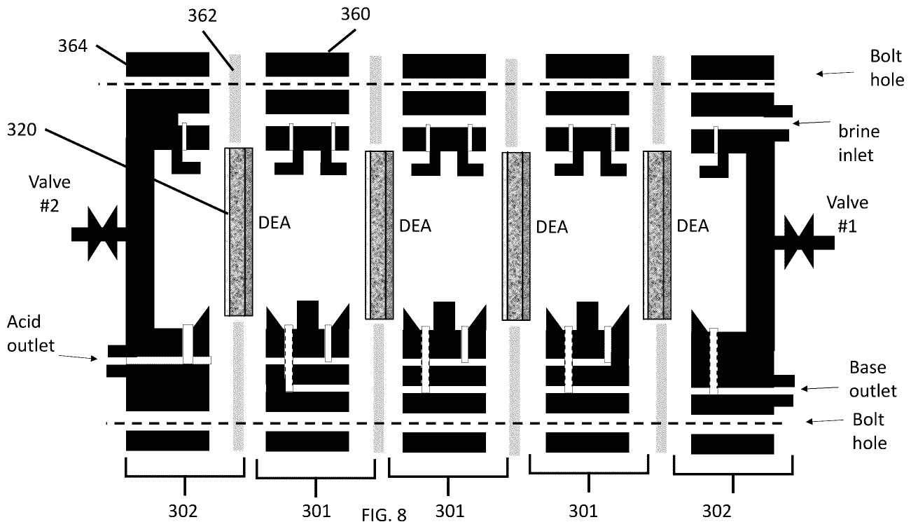

Referring now to FIG. 8, an electrolyzer stack 300 may be made up of segmented cell components 301 which are bolted together in a modular fashion. Each internal cell component 301 may include a DEA 320, a current collector (not shown), a cell separator 360, gaskets 362, and bolts (not shown), and each end cell component 302 may include the same structures except for the cell separators replaced with end plates 364. Each end plate 364, gasket 362, and cell separator 360 of each cell component 301, 302 have holes in them that align with holes in the end plates 364, gaskets 362 and cell separators 360 of adjacent cell components 301. Thus, when compressed together within the final stack structures, the holes create channels for fluid flow between adjacent cells or holes for bolts, which are located towards the periphery of the structure (e.g., at the top and bottom of the stack).

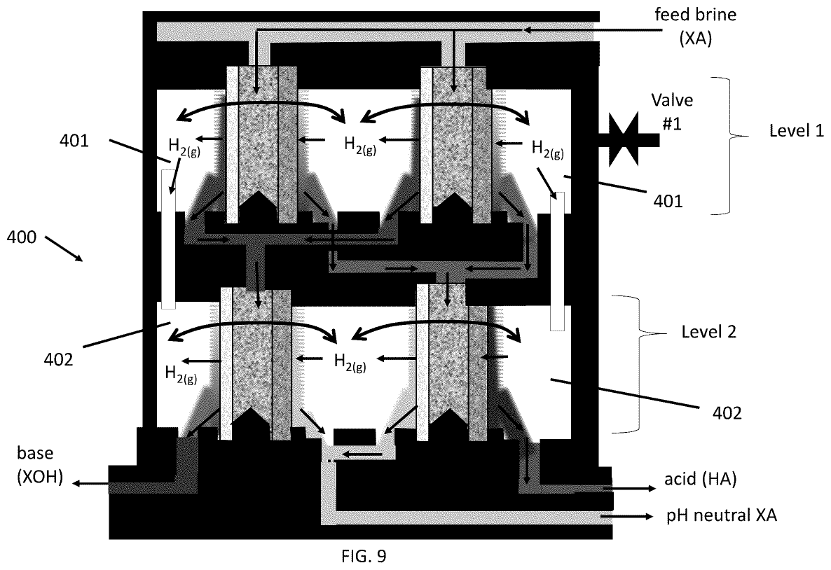

FIG. 9 shows an electrolyzer stack, generally designated by reference number 400, according to an exemplary embodiment of the present invention. In this embodiment, electrolysis cells may be connected by fluidic channels that allow for effluent from one or more cells to be directed to the inlet of other cells, thereby allowing for the generation of higher concentrations of acids and/or bases. For example, as shown in FIG. 9, the stack 400 may be made up of a first level of cells 401 and a second level of cells 402 stacked below the first level. In one embodiment, the acidic effluents from the first level of electrolysis cells 401 are combined and fed to one or more of the electrolysis cells 402 located in the second level while the alkaline effluents from the first level of cells 401 are combined and fed to one or more electrolysis cells 402 in the second level. The cells 402 in the second level may be operated with the same or different cell voltage than those in the first level. At least two levels of electrolysis cells may be incorporated into a multi-level stack and, in exemplary embodiments, three, four, five or more levels of cells may be stacked, with the same or different number of cells in each level. Although not shown in FIG. 9, additional inlet brine streams may be introduced to various levels of the stack 400.

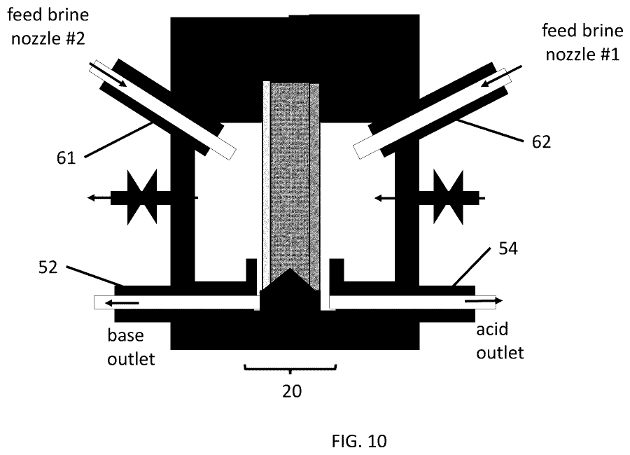

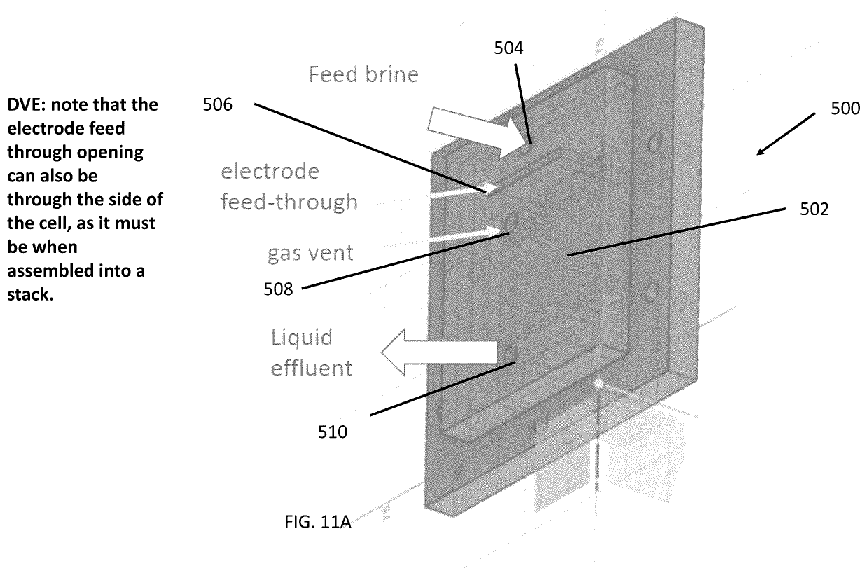

As shown in FIG. 10, in accordance with exemplary embodiments, spray nozzles 61, 62 may be used instead of fluidic channels for delivery of the electrolyte to one or both sides of the DEA 20.

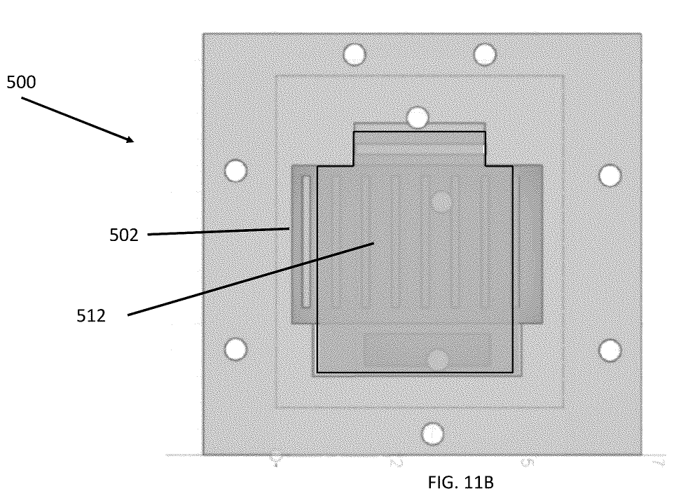

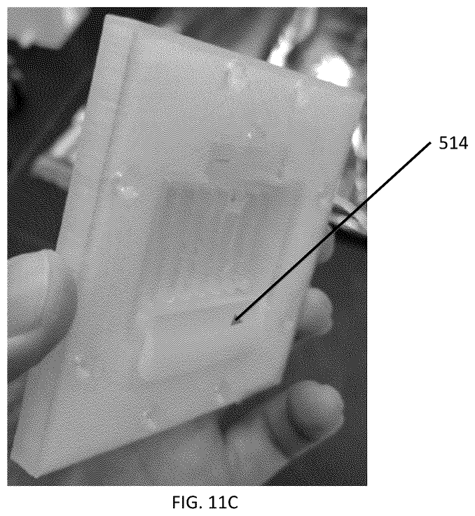

FIGS. 11A-11C show portions of an electrolytic device, generally designated by reference number 500, according to an exemplary embodiment of the present invention. The device 500 is made up of two main components, with one component 501 shown in FIGS. 11A-11C (the other component is essentially identical to the component 501 with the exception of the type of electrode and the presence of a divider and/or wedge, as described in further detail below). The component 501 may be made of materials, such as, for example, acrylonitrile butadiene styrene (ABS) or other plastics, using manufacturing methods such as, for example, injection molding. The component 501 may include a housing 502, at least one feed brine inlet 504, an electrode feed-through 506, at least one gas vent 508, and at least one liquid effluent outlet 510 all in communication with the housing 502 and an electrode 512 disposed within the housing 502. One of the two components includes a divider so that when the two components are combined with the electrodes facing one another the electrodes and divider form a DEA structure. As shown in FIG. 11C, a wedge 514 may be placed in a bottom portion of the housing 502 (or alternatively may be placed in the bottom portion of the housing of the other component of the device 500), which as described previously assists in separation of the acidic brine draining from the porous anode and the alkaline brine draining from the porous cathode. In exemplary embodiments, a current collector may be placed in the housing 502, with a portion of the current collector extending through the electrode feed-through 506 so that current can be directed to the electrode. Also, in exemplary embodiments, a gasket may be placed between the two components of the device 500. The device 500 is formed by bolting the two components together through bolt holes formed in the two components and the gasket. In exemplary embodiments, the size of the device 500 may have a width of, for example, 2 cm to 4 cm and a height of, for example, 3 cm to 7 cm. In a specific example, the device 500 has a width of 3 cm and a height of 5 cm.

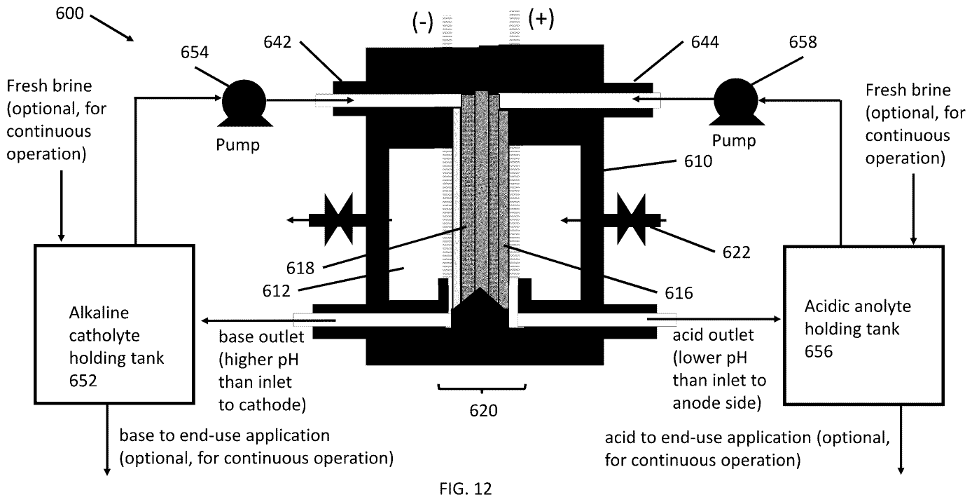

FIG. 12 shows a single cell electrolyzer, generally designated by reference number 600, according to an exemplary embodiment of the present invention. The electrolysis cell 600 is generally the same as the electrolysis cell 1 as described previously except for the modification of the electrolyte streams entering and leaving the electrolyzer being configured in a way that a first portion of the brine electrolyte is recirculated through the anode(s) and a second portion is recirculated through the cathode(s) while being temporarily stored in separate anolyte and catholyte reservoirs, respectfully. In this configuration, there are two separate feed brine streams that are not mixed. The electrolysis cell 600 includes a housing 610 with a hollow interior space 612 that is separated into two chambers by a porous divider 614. The divider 614 is interposed or sandwiched between a porous anode 616 (where the HOR occurs) and a porous cathode 618 (where HER occurs), so that the anode 616 is disposed in one chamber and the cathode 618 is disposed in the other chamber. The divider 614, anode 616 and cathode 618 may be combined together to form a divider-electrode assembly (DEA) 620. The housing 610 is equipped with an inlet valve 622 and an outlet valve 624. A first fluidic feed channel 642 delivers feed brine to the cathode side of the DEA 620, and a second fluidic feed channel 644 delivers feed brine to the anode side of the DEA 620. The use of two separate feed channels allows for control of the relative flow rates down the anode and cathode side of the DEA 620.

In the embodiment shown in FIG. 12, the two separate feed brine streams include a first stream that loops from the base outlet back to the first fluidic feed channel 642 and a second stream that loops from the acid outlet back to the second fluidic inlet channel 644. An alkaline catholyte holding tank 652 and a first pump 654 may be interposed between the base outlet and the first fluidic feed channel 642 and an acidic anolyte holding tank 656 and a second pump 658 may be interposed between the acid outlet and the second fluidic feed channel 644.

In an exemplary embodiment, a stack of cells may be used with separate feedback streams of brine on the anode and cathode sides of the system.

In an exemplary embodiment, the cell 600 (or stack of cells) is charged with an initial quantity of brine as part of a so-called “batch” operation. So long as the rate of cross-over of H+ and OH− between the two streams is less than the rate of H+ and OH− generation through electrochemical reactions, the pH of the catholyte reservoir 652 will continue to increase while the pH of the anolyte reservoir 656 will continue to decrease. This results in an overall boost in alkalinity and acidity as compared to an electrolyzer cell/stack without the feedback brine streams.

In another embodiment, fresh feed brine is continuously delivered to the catholyte and/or anolyte loops while base and acid are continuously withdrawn.

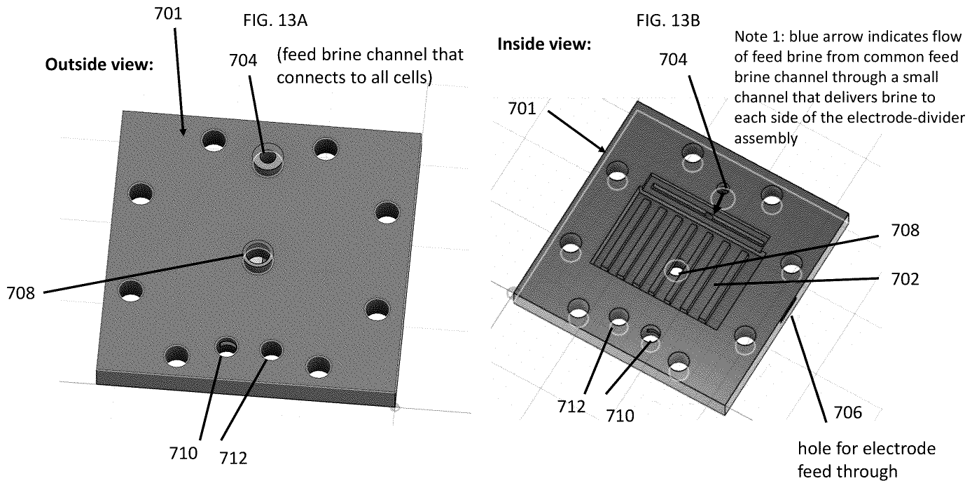

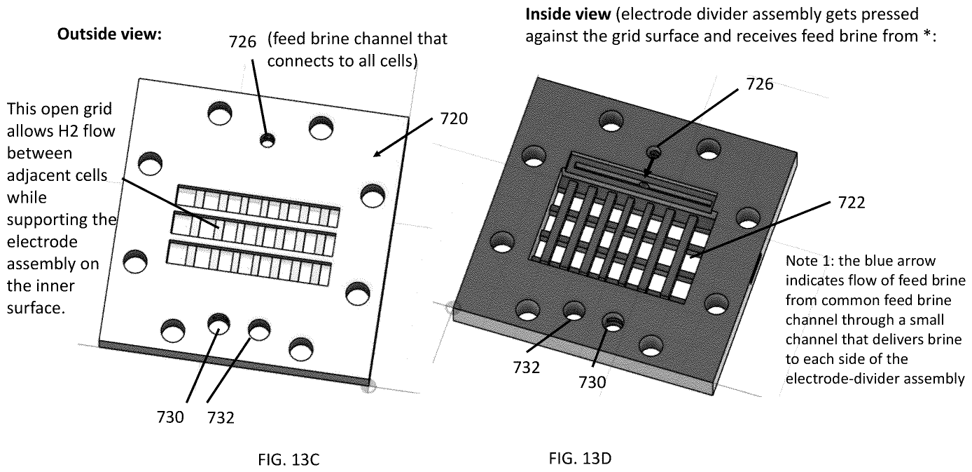

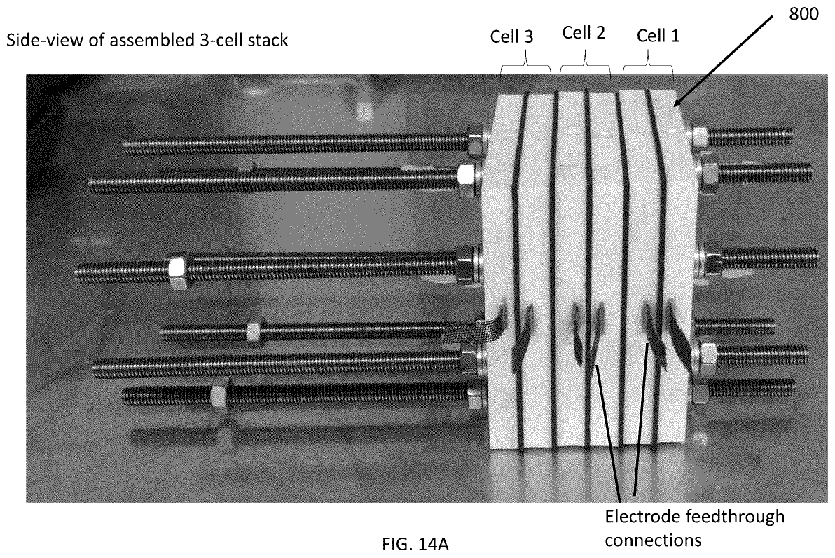

FIGS. 13A-13D show portions of an electrolytic device, generally designated by reference number 700, according to an exemplary embodiment of the present invention. The device 700 has a multi-cell stack configuration including end plate components and middle stack components.

FIGS. 13A and 13B show one end plate component, generally designated by reference number 701, according to an exemplary embodiment of the present invention (a second end plate component may be disposed at the opposite end of the stack). The end plate component 701 includes a housing 702, a feed brine inlet 704 that is in fluid communication with all the cells in the stack, an electrode feed-through 706, at least one gas vent 708, and a first liquid effluent outlet 710 and a second liquid effluent outlet 712 all in communication with the housing 702 and an electrode (not shown) disposed within the housing 702. The first liquid effluent outlet 710 includes an internal opening 711 that is in communication with the housing 702 so that one of the acid or base product streams from the DEA structure disposed within the housing 702 may flow into the first liquid effluent outlet 710. A middle cell component (described in more detail below) is disposed directly adjacent to the end plate component 701, and the middle cell component has a liquid effluent outlet channel in communication with the other of the acid or base product streams from the DEA structure disposed between the middle cell component and the end plate component 701. In exemplary embodiments, one of the first and second liquid effluent outlets of the first end plate component collects one of the acid or base product streams from the multiple cells in the stack while the other of the first and second liquid effluent outlets of the second end plate component collects the other of the acid or base product streams from the multiple cells in the stack. This configuration allows the separate acid and base effluent streams to be collected at opposite ends of the stack.

FIGS. 13C and 13D show a middle cell component, generally designated by reference number 720, according to an exemplary embodiment of the present invention. The middle cell component 720 includes a housing 722, a feed brine channel 726 in communication with the feed brine inlet 704 of the end plate component 701, a first liquid effluent outlet channel 730 in communication with the first liquid effluent outlet 710 of the end plate component, a second liquid effluent outlet channel 732 in communication with the second liquid effluent outlet 712 and an electrode (not shown) disposed in the housing 722. The outer wall of the housing 722 has an open grid structure to allow H₂ flow between adjacent cells while supporting the electrode assembly on the inner surface of the housing 722. The first liquid effluent outlet channel 730 has an opening 731 that is in communication with the housing 722 so that one of the base or acid product streams can flow into the first liquid effluent outlet channel 730. Another middle cell component may be disposed directly adjacent to the middle cell component 720 (with the housings of the two middle cell components facing one another) so that the other of the base or acid product streams can be collected from the DEA structure sandwiched between the two middle cell components. In exemplary embodiments, the side of the cell component at which the electrode feed through is disposed may alternate from one cell component to the next directly adjacent cell component so that when the cell components are stacked together, the electrode feed throughs are positioned all on the same side of the stack.

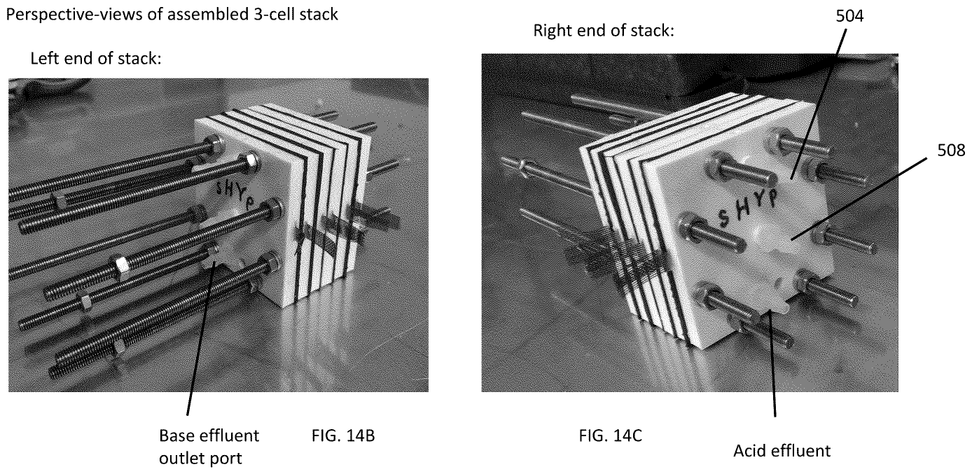

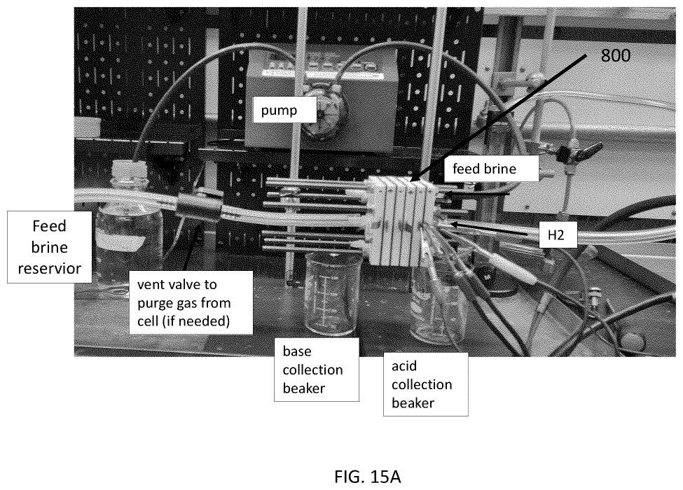

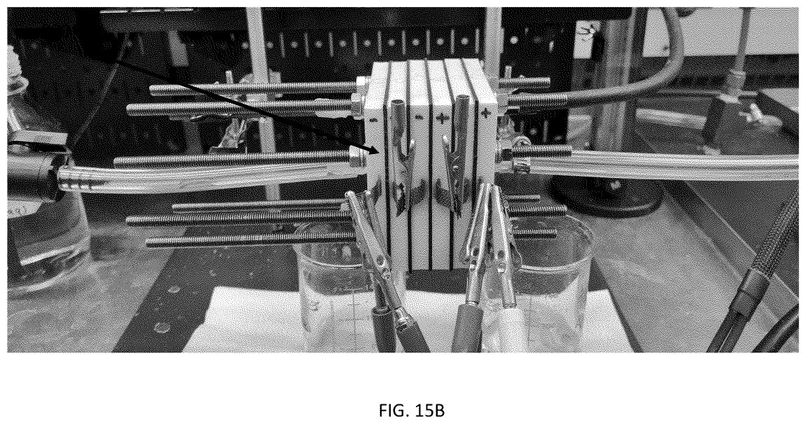

FIGS. 14A-14C are photographs of an assembled electrolytic device, generally designated by reference number 800, made up of a stack of cells (Cell 1, Cell 2, Cell 3), with each cell made up of an end plate component and a directly adjacent middle cell component or two middle cell components disposed directly adjacent to one another. Gaskets may be placed in the middle of each cell and between adjacent cells. A gasket between cells may be unnecessary if the middle-components are two-sided to receive electrodes on each side, as shown in FIG. 8. A base effluent outlet port is disposed at one end of the stack 800 and an acid effluent outlet port is disposed at the opposite end of the stack 800.

FIGS. 15A and 15B show the device 800 in a laboratory setting, with feed brine and H₂ being delivered to one side of the stack and acid and base products being collected at opposite ends of the stack. A vent valve may be used to purge gas from the stack. As shown in the photos, alligator clips connect adjacent anodes and cathodes to form a series electrical connection (i.e., “bipolar” configuration) between the three cells. Alternatively, a parallel electrical connection (i.e., “unipolar” configuration) may be used in which all of the anodes are connected together and all of the cathodes are connected together.

In an exemplary embodiment, the pH differential of the effluent streams may be further increased by pulsing the volumetric flow rate of the liquid feed brine stream to the electrolyzer such that electrolyte is flowing for some time period X and stops flowing or flows at a very low flow rate for time period Y while voltage or current is continuously applied across the electrodes. This results in a higher pH differential between the anode and cathode effluent streams than if one were to continuously flow the feed brine through the cell. Without being bound by theory, it is believed that this results from accumulation of the OH− and H+ at the cathode and anode, respectively, as electrolysis occurs during the time period Y for which the electrolyte flow has stopped. Then, when flow continues during time period X, the electrolyte sweeps the accumulated OH− and H+ generated from time period Y into the effluent streams along with additional OH− and H+ being generated during time period X.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

1. An electrolytic device comprising:
a housing; and
at least one electrolytic cell disposed in the housing and comprising:
a porous cathode;
a porous anode;
a porous divider disposed between the porous cathode and the porous anode, with the porous divider, the porous cathode and the porous anode forming an integral structure that separates the at least one electrolytic cell into a first chamber and a second chamber with the porous cathode located in the first chamber and the porous anode located in the second chamber;
at least one inlet for delivery of electrolyte to the porous cathode and the porous anode;
a first outlet for delivery of alkaline effluent from the first chamber; and
a second outlet for delivery of acidic effluent from the second chamber,
wherein reactive gas generated at one of the porous cathode or porous anode passes through the integral structure to the other of the porous anode or porous cathode.

2. The electrolytic device of claim 1, wherein the at least one electrolytic cell comprises a plurality of electrolytic cells.

3. The electrolytic device of claim 1, wherein the porous divider comprises a first layer disposed between a second and third layer, wherein the first layer is denser than the second and third layers.

4. The electrolytic device of claim 1, wherein the porous divider comprises a first layer disposed between a second and third layer, wherein the first layer is less dense than the second and third layers.

5. The electrolytic device of claim 1, wherein the divider comprises at least one channel extending through the thickness of the divider.

6. The electrolytic device of claim 1, wherein the at least one inlet comprises two inlets with one inlet for delivery of electrolyte to the cathode and another inlet for delivery of electrolyte to the anode.

7. The electrolytic device of claim 2, wherein the plurality of electrolytic cells are arranged in a side-by-side, parallel plate configuration.

8. The electrolytic device of claim 7, wherein the cathode of each electrolytic cell directly faces the anode of an adjacent electrolytic cell.

9. The electrolytic device of claim 2, further comprising a common manifold for delivery of electrolyte to each of the at least one inlets of the plurality of electrolytic cells.

10. The electrolytic device of claim 2, further comprising a common manifold for collection of alkaline effluent from each of the first outlets of the plurality of electrolytic cells.

11. The electrolytic device of claim 2, further comprising a common manifold for collection of acidic effluent from each of the second outlets of the plurality of electrolytic cells.

12. The electrolytic device of claim 2, further comprising a common anode busbar electrically connected to each of the anodes of the plurality of electrolytic cells.

13. The electrolytic device of claim 2, further comprising a common cathode busbar electrically connected to each of the cathodes of the plurality of electrolytic cells.

14. The electrolytic device of claim 2, wherein the plurality of electrolytic cells are electrically connected in series so that the electrolytic device has only a single positive terminal at one end of the device and only a single negative terminal at an opposite end of the device.

15. The electrolytic device of claim 2, wherein each of the plurality of electrolytic cells are separate modular components that are attachable together to form the electrolytic device.

16. The electrolytic device of claim 2, wherein the plurality of electrolytic cells comprise a first level of electrolytic cells and at least one other level of electrolytic cells disposed over the first level.

17. The electrolytic device of claim 16, wherein alkaline effluent generated at the at least one other level of electrolytic cells is directed to the first level of electrolytic cells.

18. The electrolytic device of claim 16, wherein acidic effluent generated at the at least one other level of electrolytic cells is directed to the first level of electrolytic cells.

19. The electrolytic device of claim 1, wherein polarity of the cathode and anode is switched to dissolve impurity species from the electrolyte that deposit on the cathode and anode during operation.

20. The electrolytic device of claim 1, wherein the alkaline effluent is recirculated back to the porous cathode.

21. The electrolytic device of claim 1, wherein the acidic effluent is recirculated back to the porous anode.

22. The electrolytic device of claim 1, wherein the electrolyte is delivered in a pulsed sequence.
